(19) United States
(12) Patent Application Publication
(10) Pub. No.: US 2016/0380770 A1
(43) Pub. Date: Dec. 29, 2016

(54) System and Method for Hash-Based Data Stream Authentication

(71) Applicant: Trifone Whitmer, Freeport, IL (US)

(72) Inventor: Trifone Whitmer, Freeport, IL (US)

(21) Appl. No.: 15/190,180

(22) Filed: Jun. 23, 2016

Related U.S. Application Data
(60) Provisional application No. 62/183,518, filed on Jun. 23, 2015.

(51) Int. Cl. H04L 9/32; G06F 21/64; H04L 9/06

(52) U.S. Cl. CPC H04L 9/3236; H04L 9/0643; G06F 21/64

(57) ABSTRACT

An authentication system and a method of creating a secure check value used by the system to verify the integrity and authenticity of data. The authentication system comprises one or more processors, data stores, and network interfaces that can communicate among themselves and with other devices. The secure check value is created by combining some or all of a cryptographic digest with the data to be secured and then outputting a secure check value by using a checksum or hash. The secure check value is associated with the data and can be used to verify the integrity and authenticity of the data after transferring the data and check value to a different location or at some point in the future.

### CROSS-REFERENCES TO RELATED APPLICATIONS

This patent application claims the benefit of U.S. Provisional Patent Application 62/183,518.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

Field of the Invention

The present invention relates to techniques for authentication and verification of data streams and, more specifically, to systems and methods for encoding a data stream with metadata to facilitate trusted transmission of the data stream from a sender to a receiver.

A data stream may be defined as a sequence of digitally-encoded signals made available over time to transmit and/or receive information, for example, among nodes in a network. A common requirement of many digital information sharing solutions is to transmit a data stream across an insecure network (such as the Internet) in such a way that the data stream cannot be read and/or manipulated by other than the intended recipient. Another common requirement of digital information sharing solutions is to ensure that a received data stream represents valid information originating from a trusted source.

Full encryption and digital signature are techniques commonly used to secure and verify data streams. Encryption is a mechanism by which a data stream is transformed so that only the sender and recipient can read and understand its substance. Digital signature is a mechanism by which a data stream is authenticated as having originated from a given sender. Both encryption and digital signature may be combined, thereby providing privacy and authentication. However, common implementations of both techniques are computationally expensive to process using known computing architectures.

By way of definition, information that can be read and understood without any special measures is called plaintext. A cryptographic algorithm, or cipher, is a mathematical function used in combination with a key, such as a word, number, or phrase, to encrypt plaintext for inclusion in a data stream. The security of encrypted data is typically dependent on 1) the strength of the cryptographic algorithm and 2) the secrecy of the key.

Symmetric-key cryptography is a mechanism by which the same key is used both by the encrypting sender and by the decrypting receiver. This encryption approach features sophisticated mechanisms to securely distribute the secret key to both communicating parties. Public-key cryptography (also known as asymmetric-key cryptography) employs key pairs: one for encrypting, and the other for decrypting. More specifically, asymmetric-key cryptography requires the use of both a public key and a secret key to secure a message transmitted and/or received among two or more endpoints within a computer network. The public key may be widely distributed, while the secret key is kept secret. A message encrypted with a recipient's public key may only be decrypted by the recipient's corresponding secret key.

Asymmetric-key cryptography has advantages over symmetric-key cryptography, including simplified key distribution, digital signature, and long-term encryption. Importantly, symmetric-key still plays a major role in the implementation of a public-key infrastructure (PKI) because asymmetric-key encryption algorithms may be more complex and, therefore, more computationally expensive than symmetric-key algorithms.

Also by way of definition, a common digital signature technique is called hashing. Hashing produces a message digest that is a small and unique representation of a larger, complete message. Hashing algorithms involve one-way encryption (i.e., the message may not be derived from the digest). Reasons for producing a message digest include the following:

1) The integrity of the message being sent may be preserved (i.e., any message alteration may be readily detected);

2) The digital signature may be applied to the digest, which is usually considerably smaller than the message itself;

3) Hashing algorithms are less computationally expensive (e.g., faster) than typical encryption algorithms (both asymmetric or symmetric).

A Hash Message Authentication Code (HMAC) is a type of asymmetric cryptographic message authentication code that uses a secret key and a cryptographic hash function to generate an authentication code for an endpoint. HMACs may be used to verify data integrity as well as the authenticity of a message. Messages signed with an HMAC signature typically are sent from endpoint to endpoint in an unmodified fashion because changing even a single bit of the message alters the result of the hashing algorithm that generates the HMAC signature. If the signature of a message is altered, then the receiving endpoint will not be able to verify the signature of the message and the communication of the message will fail.

The computer networking industry is experiencing advancements in secure data sharing. Some of these techniques may be applicable to certain aspects of the present application.

Background Art

U.S. Pat. No. 8,131,998 to Wang et al. discloses a system, apparatus and method for transparently authenticating continuous data streams. A continuous data stream is divided into data blocks. Block authentication code(s) are determined using the data in the data blocks, a hash function, and a key. The block authentication code(s) are embedded into the data block(s) by adjusting the timing between the packets in the data block(s). Timing delays may be used to separate the blocks. The continuous data stream may be received and authenticated by comparing an extracted block authentication code with a new calculated content-based block authentication code.

U.S. Patent Application No. 20140156997 by Rao et al. discloses systems and methods for authenticating an encoded multimedia stream using digital signatures. Metadata is data associated with the video streams, audio streams or images, such as global positioning system (GPS) co-ordinates of a location and the like. In one embodiment, the digital signatures are generated, in real-time, using associated multimedia stream properties. The encoded multimedia stream including the digital signatures is transmitted and subsequently received. One or more digital signatures associated with one or more decodable units in the received encoded multimedia stream are generated. In one embodiment, the digital signatures associated with the decodable units in the received encoded multimedia stream are generated using the associated multimedia stream properties. The embedded digital signatures are extracted from the received encoded multimedia stream. For example, the user specific data including the embedded digital signatures is extracted. The extracted digital signatures are compared with the generated digital signatures to determine whether the transmitted encoded multimedia stream and the received encoded multimedia stream are identical or not.

U.S. Pat. No. 7,464,266 to Wheeler discloses method and system of synchronous broadcast communications by applying signature keys using hashing functions. Each subsequent transmission in a sequence includes a hashing function that is dependent on a preceding hashing function from a following portion of the sequence. The first transmission in the sequence is hashed using a secret key that is revealed to the client device only at the end of that transmission, and whose authenticity and integrity is guaranteed by other means. Each client device can utilize an internal counter for the current time or the block number in the transmission sequence to maintain synchronized transmissions in the event that a particular portion of the sequence is missed, and to validate signature keys. Because of the initial synchronization and the synchronized counters, unauthorized retransmissions can be detected and rejected.

### BRIEF SUMMARY OF THE INVENTION

One problem with employing traditional encryption or signatures is that the computational overhead required by such algorithms prevents many data streams, such as those transmitted from inexpensive cameras and other devices which may lack a dedicated processor, from being verified in any manner. Additionally, even if a device has adequate computing resources to perform conventional encryption, inherent problems exist with common PKI implementations, mainly stemming from trust. More specifically, PKI requires a chain of trust in order to validate certificates and keys. However, successful attacks on that chain of trust are possible by hacking or otherwise spoofing high-level certificate authorities. Furthermore, concern is growing in the industry over possible vectors of attack on traditional encryption.

Streamlining the digital signature process and introducing faster processors seem to be the main methods currently used to implement conventional signatures on lower-cost devices. Also, stronger forms of encryption on the certificates are being used to address PKI trust issues, but typically at the expense of the computational cost of the signatures. Furthermore, current attack vectors are being thwarted primarily by increasing the complexity of conventional encryption.

What is needed is a computer-implemented system and/or method capable of equipping devices that have little processing power to secure and verify data streams exchanged across an insecure network. In addition, a system and/or method which can supplement traditional encryption is needed to reduce the vulnerability of encryption to current and future attacks. Furthermore, a system and/or method is needed which allows an entity to retain complete control of its keys in order to prevent PKI trust issues.

### BRIEF DESCRIPTION OF THE SEVERAL VIEWS OF THE DRAWINGS

FIG. 1 is a schematic block diagram of a hash-based data stream authentication system according to an embodiment of the present invention.

FIG. 2 is a flowchart illustrating sender steps performed by a hash-based data stream authentication system according to an embodiment of the present invention.

FIG. 3 is a flowchart illustrating receiver steps performed by a hash-based data stream authentication system according to an embodiment of the present invention.

FIG. 4 is a flowchart illustrating validation steps included in the receiver steps depicted in FIG. 3.

FIG. 5 is a diagram illustrating exemplary data structures used in the steps depicted in FIGS. 2, 3, and 4.

FIG. 6 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention text, as shown and described by the various figures and accompanying text, provides a computer-implemented system and method that may detect tampering, looping, spoofing, and/or other modification of a data stream as exchanged using an insecure network. More specifically, the computer implementation described herein may include use of synchronized counters to generate Hash-based Message Authentication Codes (HMAC), and then may calculate a computationally-inexpensive check value that may be attached to a data stream to be secured.

The computer-implemented method of providing computationally-inexpensive check values may advantageously require fewer computer processing resources than those demanded by known encryption and/or signatures. Furthermore, the computer-implemented method described herein may advantageously solve the problem of maintaining trust with PKI keys by including the initial sharing of a single secret key which may be used by both sending and receiving devices to coordinate their check values. Also, the computer-implemented method described herein may advantageously ameliorate the challenge of countering attack vectors because such attacks on conventional encryption are not effective against HMACs. Additionally, the present invention may be installed to a device that already uses conventional encryption in order to advantageously provide an additional layer of assurance that exchanged data streams are authentic, since an adversary would have to develop two unrelated attack vectors and deploy them simultaneously in order to fully compromise the combined system.

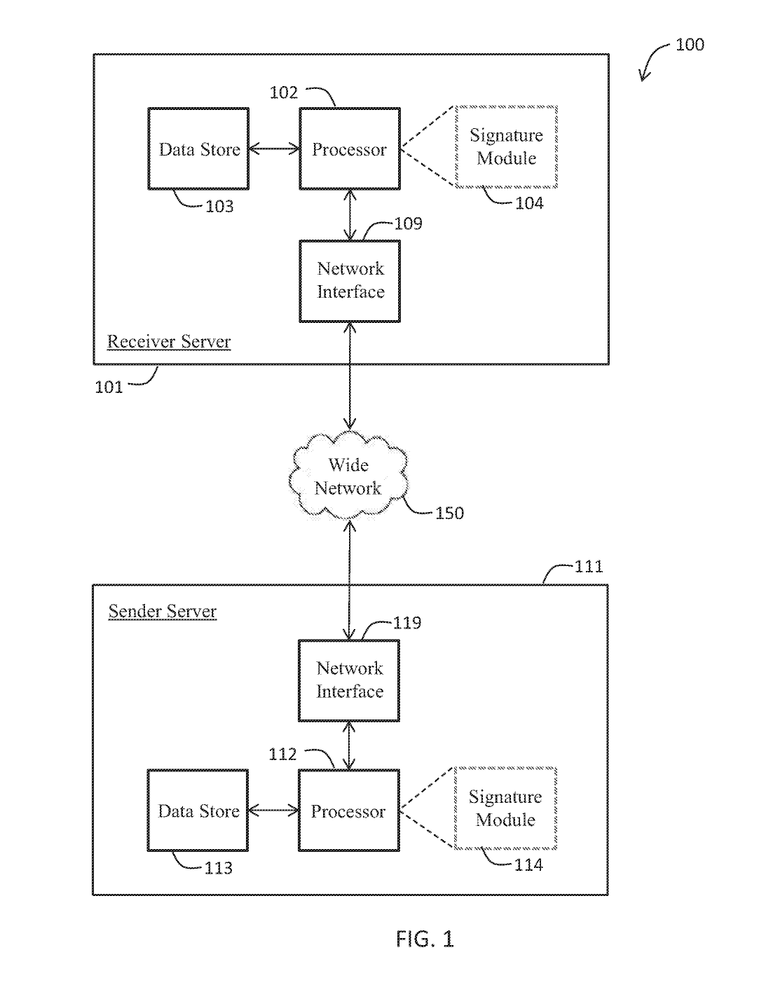

Referring to FIGS. 1-6, a hash-based data stream authentication system and associated methods, according to an embodiment of the present invention, are now described in detail. Throughout this disclosure, the present invention may be referred to as a data stream authentication system, a data authentication system, a packet processing system, a data validation system, a data verification system, a data privacy system, a data security system, a computer program product, a computer program, a product, a system, a device, and a method. Furthermore, the present invention may be referred to as relating to the implementation of encryption and digital signature processes. Those skilled in the art will appreciate that this terminology does not affect the scope of the invention. For instance, the present invention may just as easily relate to the implementation of secure data sharing in general.

Example methods and systems for a hash-based data stream authentication system are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation. Some of the illustrative aspects of the present invention may be advantageous in solving the problems herein described and other problems not discussed which are discoverable by a skilled artisan.

Referring now to FIG. 1, the hash-based data stream authentication system 100 according to an embodiment of the present invention will now be discussed in greater detail. An embodiment of the invention, as shown and described by the various figures and accompanying text, provides a hash-based data stream authentication system 100 that may implement a computationally-efficient method of detecting and preventing unauthorized modification of network-based data communications. For example, and without limitation, the system 100, according to an embodiment of the present invention, may include a Receiver Server 101, which may be in data communication with a Sender Server 111. For example, and without limitation, the Receiver Server 101 may be coupled to the Sender Server 111 using a wide area network (WAN) 150 such as the Internet. Those skilled in the art will appreciate that the implementation of protected data communication between the Receiver and Sender Servers 101, 111, as described herein, may be applied to common data communication media including, but not limited to, a Personal area network (PAN), a Local area network (LAN), a Metropolitan area network (MAN), a Storage area network (SAN), an Enterprise private network (EPN), and a Virtual private network (VPN).

For example, and without limitation, either of the Receiver Server 101 and the Sender Server 111 may comprise a web browser and a communication application. “Web browser” as used herein includes, but is not limited to, any application software or program (including mobile applications) designed to enable users to access online resources and conduct trusted transactions over a network such as the Internet. “Communication” as used herein includes, but is not limited to, electronic mail (email), instant messaging, mobile applications, personal digital assistant (PDA), a pager, a fax, a cellular telephone, a conventional telephone, television, video telephone conferencing display, other types of radio wave transmitter/transponders and other forms of electronic communication. For example, and without limitation, the Receiver Server 101 and/or the Sender Server 111 may be configured to execute web applications designed to function on any cross-platform web server running Apache, MySQL, and PHP. Those skilled in the art will recognize that other forms of communication known in the art are within the spirit and scope of the present invention.

Continuing to refer to FIG. 1, the Receiver Server 101 may comprise a processor 102 that may accept and execute computerized instructions, and also a data store 103 which may store data and instructions used by the processor 102. The processor 102 may be configured to direct input from other components of the Receiver Server 101 to the data store 103 for storage and subsequent retrieval. Similarly, the Sender Server 111 may comprise a processor 112 that may accept and execute computerized instructions, and also a data store 113 which may store data and instructions used by the processor 112. The processor 112 may be configured to direct input from other components of the Sender Server 111 to the data store 113 for storage and subsequent retrieval.

Each of the Receiver Server 101 and the Sender Server 111 may be configured in data communication with each other, and also with other computing devices. For example, and without limitation, the processor 102 may be in data communication with external computing resources, including the Sender Server 111, through a direct connection and/or through a network connection 150 facilitated by a network interface 109. Also for example, and without limitation, the processor 112 may be in data communication with external computing resources, including the Receiver Server 101, through a direct connection and/or through the network connection 150 facilitated by a network interface 119.

According to one embodiment of the present invention, Signature module 104 instructions may be stored in the data store 103 and retrieved by the processor 102 for execution. Similarly, Signature module 114 instructions may be stored in the data store 113 and retrieved by the processor 112 for execution. Although the data stores 103, 113 of FIG. 1 are each shown as local storage, a skilled artisan will recognize that these data stores 103, 113 may alternatively, or in addition, comprise one or both of server-based storage and cloud storage. Each of the Signature modules 104, 114, according to embodiments of the present invention, may be characterized as a function or other unit of code that may be added to existing hardware or software that generates and/or interprets a data stream to be protected. For example, and without limitation, the Signature module 104, 114 may implement a shared secret key and also an internal counter value. The internal counter value may not be shared, but instead may be synchronized, for example, and without limitation, between the Signature module 114 of the Sender Server 111 and the Signature module 104 of the Receiver Server 101. Either of the Signature module 114 of the Sender Server 111 and the Signature module 104 of the Receiver Server 101 may be configured to support both preparation of a locally-created data stream for transmission, and interpretation of a remotely-created data stream upon receipt.

Exemplary operations of the Signature module 104, 114 are described individually in greater detail below. Those skilled in the art will appreciate, however, that the present invention contemplates the use of computer instructions that may perform any or all of the operations involved in data stream protection, including encryption, and digital signing. The disclosure of computer instructions that include Signature module 104, 114 instructions is not meant to be limiting in any way. Those skilled in the art will readily appreciate that stored computer instructions may be configured in any way while still accomplishing the many goals, features and advantages according to the present invention.

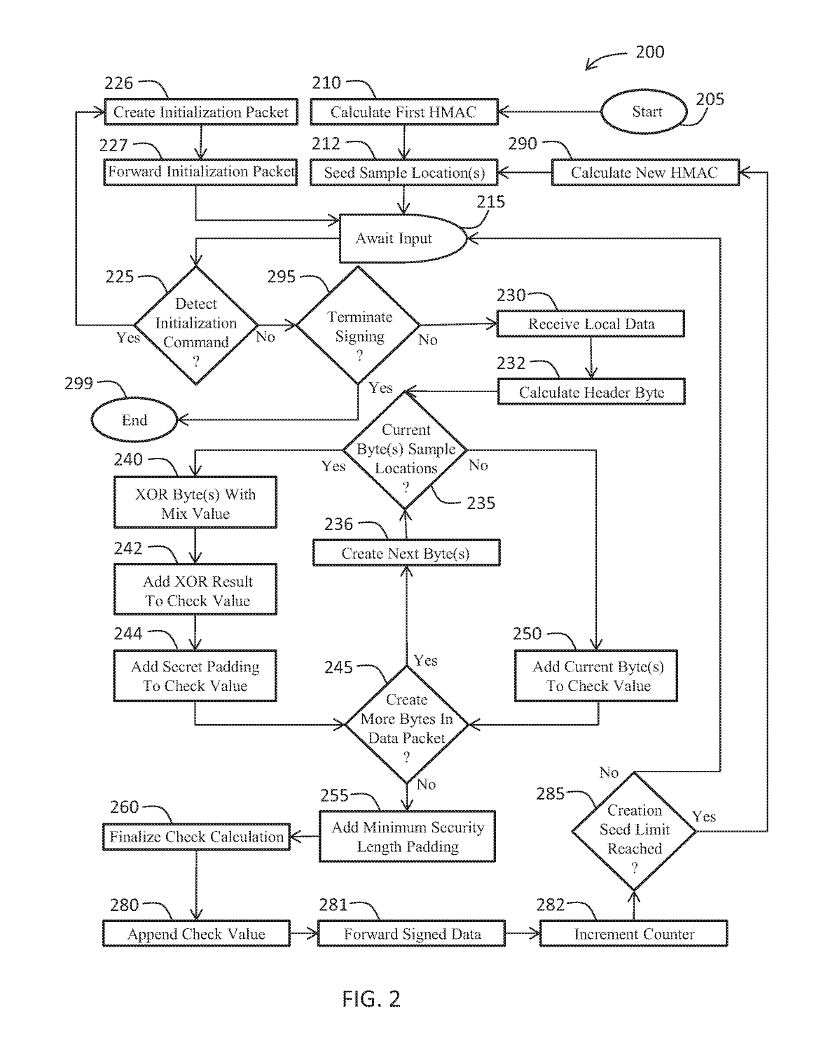

Referring now to FIGS. 2, 3, and 4, and continuing to refer to FIG. 1, a method aspect of protecting data communication between networked computing assets using a hash-based data stream authentication system 100, and according to an embodiment of the present invention, will now be discussed in greater detail. A variety of methods for sharing and generating keys, as described below, may be successfully applied to the methods disclosed herein.

Upon startup of a communicating endpoint (i.e., Sender server 111, Receiver server 101), the installed Signature module 114, 104 may initialize and execute using idle cycles of the local processor 112, 102. For example, and without limitation, initialization upon startup of the Signature module 114, 104 may be computationally-economical and minimally-intrusive because responsibility for input/output (I/O) may remain with native processes executed by the endpoint's processor 112, 102.

Generally speaking, all data from the Sender server 111 may first be routed to the Signature module 114 before being packaged for transmission by the Sender server 111's I/O. For example, and without limitation, the Sender server 111 may already be configured with executable logic required to interact with an external communication protocol (for example, and without limitation, Ethernet). The existing logic may be capable of encapsulating a data stream in Ethernet frames, with the appropriate subdivision and headers. In one embodiment of the present invention, as described in more detail below, the Sender server 111 may first send the data stream to the Signature module to calculate a check value, and the Signature module 114 may then forward the data (including its own header byte and signature bytes) to the local I/O module, which will then handle the communication-level encapsulation.

Continuing to refer to FIG. 2, from the start at Block 205, the Signature module 114 of the Sender server 111 may calculate the first Hash-based Message Authentication Code (HMAC) based upon a secret key and a local counter value (Block 210). As described below, a variety of methods for setup and sharing of the secret key may be supported in various embodiments of the present invention. The Signature module 114 then may use this first HMAC to calculate an initial sample array location(s) (Block 212). The Signature module 114 may then await input (Block 215), such as detection of an initialization command originating from the local server (Block 225), to trigger creation of an Initialization packet (Block 226) using the first HMAC and sample array location(s).

At Block 227, using data communication between the Sender server 111 and a Receiver server 101 that may be established by the unsecured input/output (I/O) elements of each device (e.g., the servers' respective Network Interfaces 119, 109 exchanging data across the Internet 150), the Sender server 111 may forward the Initialization packet to the Receiver server 101.

If no triggering input is detected at Blocks 215, 225, then the Signature module 114 may be configured to terminate (Block 295), for example, and without limitation, after a preset period. Otherwise, successful creation and forwarding of the Initialization packet may be followed by processing of transmittable data received by the Signature module 114 from the local server (Block 230). For example, and without limitation, the Sender server's 111 Signature module 114 may sign and forward locally-created data as described below.

At Block 232, the Signature module 114 may first calculate and prepend a header byte that may contain information about packet size and current counter value. The process of header value calculation is described in greater detail below. The Signature module 114 may then prepare to calculate an incremental check value (between Blocks 235 and 245). For example, and without limitation, the check value may be characterized as a Fletcher-32 checksum, although a person of skill in the art may recognize that any low-overhead method capable of detecting small changes in data, such as a Cyclic Redundancy Check (CRC) or other Fletcher checksum, may be used as the check value. The Signature module 114 may read in the data stream byte-by-byte (Blocks 245 and 236), and calculate an incremental check value on each byte (between Blocks 235 and 245). After all desired bytes have been added to the transmittable data packet (Block 245), the Signature module 114 may then finalize the check value calculation (Block 260) and append the check value to the data packet (Block 280) before forwarding the data packet as signed data (Block 281) unmodified to the I/O of the Sender server 111.

Continuing to refer to FIG. 2 at Block 235, at specific bytes which may be determined by the sample location array(s) the check value may be calculated on a modified version of the data stream (between Blocks 240 and 244). For example, and without limitation, the modification may be determined by the two or more HMAC bits being used for the current packet. However, even for these modified check bytes, the data stream may be forwarded unmodified to the I/O at Block 281. After all of the bytes have been read at Block 245, or if a preset packet size has been reached, the Signature module 114 may finalize the check value at Block 260 (for example, and without limitation, Fletcher-32 requires a final reduction before the checksum is ready) and may forward the signature bytes to the I/O for transmission as part of the signed data packet (Block 281).

At Block 282, the Signature module 114 may increment the internal counter of the Sender server 111 in preparation for the next transmission. If a limit on the size of sample array location(s) is not reached (Block 285), processing of the next transmission (e.g., subsequently-received local data) may proceed using the previous working HMAC. If, on the other hand, a seed limit is reached at Block 285, then the main loop of the Signature module 114 (also representative of a second thread if employed in a multi-threaded environment) may be responsible for calculating a new HMAC (Block 290) every time the previous working HMAC has been fully consumed.

Referring again to FIG. 1, at the Receiver server 101 the I/O module may receive data packets and strip out the communication-level encapsulation (for example, the Ethernet headers and CRC values), and then forward the signed data stream to the Receiver server's 101 Signature module. The Receiver server's 101 Signature module 104 may then strip out the header byte and signature bytes inserted by the Sender server's 111 Signature module and verify the packet. If the packet is verified, the Signature module 104 of the Receiver server 101 may send a signal to the main code of the Receiver server 101 allowing work to proceed. Otherwise, the Receiver server's 101 Signature module 104 may sound an alert and optionally halt the main code. As is the case with the Sender server 111 described above, the existing I/O for the Receiver server 101 may not need to be modified to handle the addition of Signature module 104, but instead may handle a signed data stream as a regular data stream and may be ignorant about the added header and signature bytes. The I/O function of Receiver server 101 may subdivide and encapsulate the signed data stream normally.

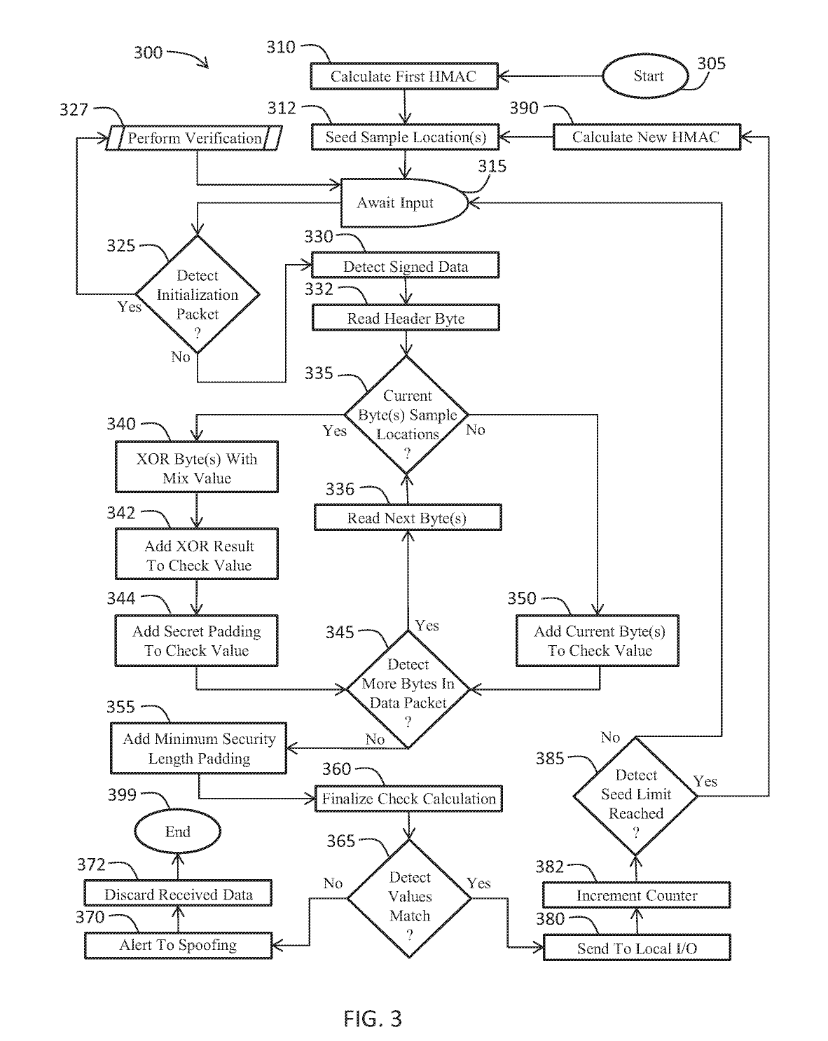

Referring now to FIG. 3, and continuing to refer to FIG. 1, the Signature module 104 of the Receiver server 101 may operate in a fashion similar to the Signature module 114 of the Sender server 111. From the start at Block 305, the Signature module 104 may calculate a first Hash-based Message Authentication Code (HMAC) based upon the secret key and a local counter value (Block 310). The variety of methods described below for setup and sharing of the secret key may be supported in various embodiments of the present invention. The Signature module 104 then may use its first HMAC to calculate an initial sample array location(s) (Block 312). The Signature module 104 may then await input (Block 315), such as detection of receipt of a remotely-created Initialization packet (Block 325) using data communication between the Sender server 111 and the Receiver server 101 that may be established by the unsecured input/output (I/O) elements of each device (e.g., the servers' respective Network Interfaces 119, 109 exchanging data across the Internet 150).

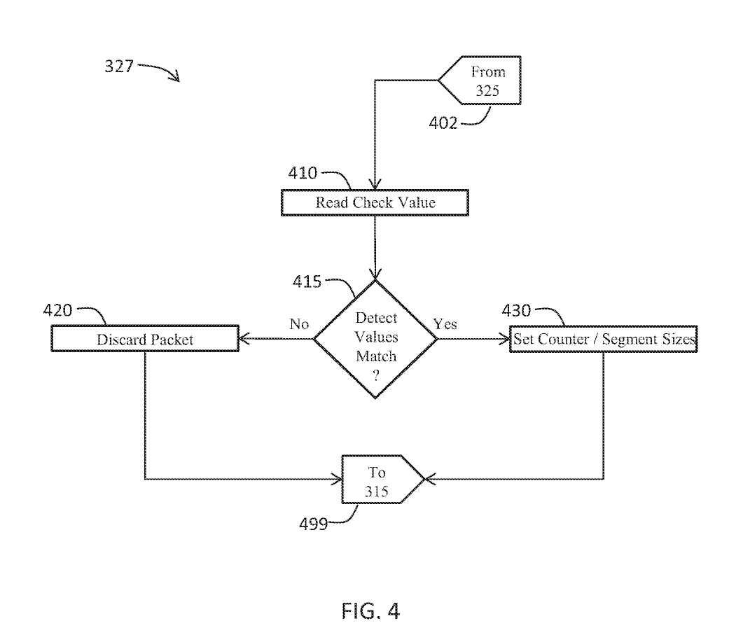

Referring now to FIG. 4, and continuing to refer to FIG. 3, the Signature module 104 may perform verification of the Initialization packet at Block 327. More specifically, the Signature module 104 may read the check value from the Initialization packet (Block 410), and compare it to a locally-calculated check value (Block 415). Detection of a mismatch of the respective check values may, for example, and without limitation, cause the Signature module to discard the packet as untrustworthy (Block 420) before returning control to await further input (Block 499). Detection of a match of the received and locally-calculated check values may cause the Signature module to update the local counter and to set full segment sizes to packet values (Block 430) before continuing with signed data processing (Block 499).

Continuing to refer to FIG. 3, successful verification of the Initialization packet may be followed by receipt by the Signature module 104 of related signed data (Block 330). For example, and without limitation, the Sender server's 111 Signature module 114 may interpret remotely-created data as described below. For example, and without limitation, the Signature module 104 may read in the header value at Block 332. The Signature module 104 may then prepare to calculate the incremental check value (between Blocks 335 and 345). The Signature module 104 may continue to read in the incoming data stream (Blocks 345 and 336) and calculate the check value in the same way as the Sender server 111 Signature module 104, including calculating a modified version at the bytes indicated by the check-location array (Blocks 340, 342, and 344). After the packet size is reached and/or the data stream ends (Block 345), the Receiver server 101 Signature module 104 may finalize its local check value (Block 360) and compare it with the received signature bytes (Block 365). If the signature bytes match, then the Signature module 104 may signal the main code of the Receiver server 101 that the data stream is secure and/or may forward the data stream for processing by the main code (Block 380). If the signature bytes do not match at Block 365, the Signature module 114 may signal an alarm (Block 370) and/or may optionally halt processing of the main code until the situation is resolved (Block 372). In one embodiment, the Receiver server 101 Signature module 104 may then perform optional housekeeping tasks to better maintain synchronization with the Sender server 111 and to prevent replay attacks.

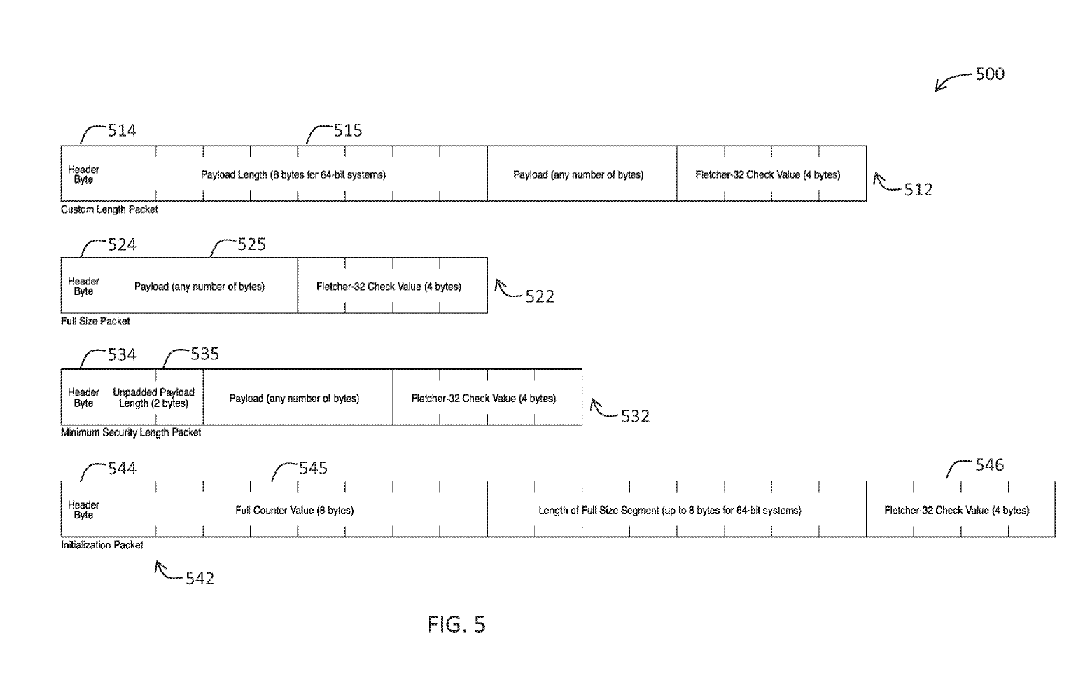

Referring now to FIG. 5, and referring again to FIGS. 2, 3, and 4, for example, and without limitation, the Initialization packet 542 created at Block 226 may be of a Minimum Security Length packet type that may contain a special header value 544 and a full transmission of the Sender server's 111 counter value 545, and may be signed using sample array locations that are valid at that counter value. In one embodiment, with no provisions for malicious packet blocking which would cause the counters to vary significantly, the respective counters on the Sender server 111 and Receiver server 101 may still be at or near the same value, which may allow the Receiver server 101 to verify the signature (Block 410) on the Initialization packet 542 and reset Receiver server's 101 internal counter to the received value (Block 430).

In another embodiment, the Receiver server 101 may have a buffer at least large enough to hold the entire Initialization packet 542. In the event that an adversary would be able to block valid transmissions from the Sender server 111, the Sender server's 111 counter may advance without the Receiver server's 101 counter advancing (e.g., an error condition at Block 415). In order to prevent this, the Receiver server 101 may buffer the entire Initialization packet 542 and then may calculate the sample array locations (Block 312) for whatever counter value 545 was transmitted in the Initialization packet 542 (Block 227) before then calculating the check value 546 for the Initialization packet 542 using the new sample array locations. If this new calculation matches at Block 415, the Receiver server 101 may advance its counter (Block 430) to match the received counter value 545 and operation may resume at Block 415.

For example, and without limitation, the Receiver server's 101 counter reflecting a tally that is higher than the Sender server's 111 counter may indicate a replay attack. If the Initialization packet 542 contains a counter value 545 lower than the Receiver server's 101 counter, the Receiver server 101 may sound an alarm and/or ignore the packet 542 (Block 420). For example, and without limitation, such an alarm may signal either that a replay attack is in progress or that further human intervention is required. Also for example, and without limitation, the secret keys may need to be changed and the counters reset to 0. Also for example, and without limitation, the Sender server's 111 counter may need to be advanced to be higher than the Receiver server's 101 counter and a new Initialization packet sent.

Continuing to refer to FIG. 5, the Minimum Security Length mentioned above may be defined as a packet with the fewest bytes possible while still maintaining security. The significance of this boundary is that shorter packets may not provide enough possible sample locations to hide the sample locations from an adversary. In the example of a 16-byte packet with 16 sample locations, there may exist only one possible set of sample locations (each byte may be a sample location if there are only 16 bytes), meaning that the adversary may be capable of determining the sample location settings. A Minimum Security Length longer than 16 bytes may provide adequate security based on application requirements. For example, and without limitation, a Minimum Security Length set to 160 bytes may provide 10 possible sample locations per interval. Packets less than the Minimum Security Length may be padded for the purpose of the check value (Blocks 255 and 355), but may still be sent unmodified (like all packets).

Also for example, and without limitation, if the packet is only 120 bytes long, and the Minimum Security Length is determined to be 160 bytes, then the sample locations may be calculated based on a length of 160 bytes. The data may be read in and transmitted as usual, with mixing at the appropriate bytes. Subsequently, once the 120 bytes have been sent, the signature modules may continue internally running through the remaining 40 padding bytes and mixing the null bytes with the mix array value at the appropriate sample locations (Blocks 255 and 355). This calculation may proceed very quickly because no I/O may be performed, and because the padding of bytes may be computationally inexpensive. The check value may then be appended after the transmitted 120th byte, with the null padding bytes not being transmitted, which also may advantageously save on bandwidth.

For example, and without limitation, a Minimum Security Length packet 532 also may have a size byte 535 transmitted after the header byte 534 to indicate what the actual packet size (before padding) should be. In the example case of the 160-byte Minimum Security Length, the size byte may be a single byte (which ranges from 0-255). If the Minimum Security Length is larger than 255, then the size byte may actually become a size code of two or more bytes, depending on the magnitude of the Minimum Security Length.

As mentioned above, an Initialization Packet 542 may be characterized as being of a Minimum Security Length packet type 532 with a specific header value. The header byte 544 may be a single byte containing a two bit field which may describe the incoming packet (for example, and without limitation, four possible values using the two bits to indicate the following packet types: Initialization Packet 542, Full Size Packet 522, Minimum Security Length Packet 532, and Custom Length Packet 512) and the six least significant bits of the sender's counter value 545. The six counter bits may provide a range of 0-63, and may allow the Receiver server's 101 Signature module 104 to order the packets appropriately within each HMAC. Doing so may advantageously overcome network jitter which may swap the order of some packets. The entire payload of the packet may include the full counter value 545, which may take multiple bytes depending on how long the Sender server 111 has been operational. The Initialization Packet 542 may be signed as any other packet, and may use the standard Minimum Security Length packet padding as well.

The Full Size Packet 522 header code may inform the Receiver server 101 that the packet is the predetermined “workhorse” length packet. For example, and without limitation, this packet length may be shared in the Initialization Packet after the full counter value is sent or, alternatively, it may be preset at the time of fabrication of the included I/O components. It may represent the largest packet size that still maintains security, or that fits the data stream in some manner. For example, and without limitation, a video stream may have the Full Size Packet length set to the byte size of a single frame or field.

Optional Custom Length Packets 512 may be supported in certain embodiments of the present invention. The Custom Length Packet header code may signal that the header byte 514 is followed by a length code. For example, and without limitation, embodiments of the present invention designed for 64-bit systems may use an eight byte length code as the maximum length. This means that a Custom Length Packet 512 technically may have a nine byte header, rather than the usual single byte header, since it may include the header byte 514 and eight length bytes. The Receiver server 101's Signature module 104 may use the length code to calculate the proper sample location values.

For transmissions that are a non-integer multiple of the Full Size Packet 522, the transmission may be sent using as many Full Size Packets 522 as possible, and then may be sent with either a Custom Length Packet 512 (that is longer than the Minimum Security Length) as the remaining bytes (if Custom Length Packets are supported), or a series of Minimum Security Length packets 532 as the remaining bytes (if Custom Length Packets 512 are not supported). If the remaining bytes are not an integer multiple of the Minimum Security Length, then the final packet may be sent as a Minimum Security Length Packet 532 with padding.

Further security may be provided by the utilization of secret padding bytes which use any number of HMAC bits per packet. By way of example and not as a limitation, there may be 4 HMAC bits per packet. Such an implementation would provide sixteen possible secret-padding values. Theoretically, the adversary may be capable of determining the check locations by brute force even though the adversary is not able to determine the exact solution by brute force. This may be because collisions lead to multiple possible check locations for each signature, so the adversary can't be certain which is the proper one, but the adversary may be able to ascertain which bytes are check locations based upon the set of possible check locations. With this knowledge, the adversary could theoretically modify any byte that was never checked, and perform an offset-modification to the valid signature.

By way of example, and not as a limitation, with Fletcher-32, if the adversary wishes to modify the last byte (and the adversary knows the last byte cannot be a check value for the set of possible check locations), the adversary could add “1” to the last byte and then add “1” to the second half of the signature and 1*(the number of bytes in the packet) to the first half of the signature. This would result in a valid signature and modification, and is referred to herein as an “offset-attack” because it offsets both a chosen byte and the signature. There are many contingencies that must occur for an offset-attack to be a possible attack, but if these contingencies are met, adding the secret-padding bytes method will counter the offset-attack.

By using HMAC bits, which are secretly generated on both sender and receiver, to vary the length of the packet in a hidden fashion, the adversary will never be able to ascertain exactly how to offset the first half of the signature, which requires knowledge of the number of bytes used to create the Fletcher value. In embodiments in which four HMAC bits are utilized, the adversary has, at best, a 1/16 (6.25%) chance of correctly guessing the proper offset-attack. The HMAC bits are never reused, so the possibility of the adversary monitoring multiple consecutive packets to try to deduce the proper offset-attack value is eliminated. This 1/16 chance is independent as well, so the chance of the adversary properly guessing two offsets in a row is ( 1/16)², which is a 0.4% chance, or three standard deviations from the mean. The adversary would have only a ( 1/16)³, or 0.02% chance of guessing three offsets in a row.

After every string of mixed bytes, the sender or receiver may simply insert a number of bytes into the calculation of the check value (Blocks 244 and 344). A loop may be used which runs from 1 to the HMAC value+1, and at each loop instance, the current loop counter may be inserted. By way of example, and not as a limitation, on the second run of the loop, the loop counter would be “2”, so a byte containing the number “2” may be mixed in. The next iteration may mix in “3”, and so on. Other padding values may be used, for example and without limitation, all 0's, all 1's, or the HMAC value.

Four HMAC bits gives a range of 0-15, but inserting 0 secret padding bytes may be forbidden as the use of 0 secret padding bytes may be readily apparent to the adversary. Therefore, the range may be shifted up to 1-16 insertions after each string of mixed bytes. Strings of bytes are used because if the packet being checked is long enough, there may be multiple bytes mixed in a row for each check location. When using Fletcher-16, 1-16 bytes are inserted after each string. For efficiency, 2-32 bytes may be inserted when using Fletcher-32. Fletcher-32 calculates the incremental sum in 2-byte blocks, so it is more efficient to insert 2-byte chunks equal to the pad value rather than single bytes. There may also be an additional set of “secret-padding bytes” added at the end of each packet, just before the check calculation is finalized. This may prevent the adversary from modifying the final byte at will.

The secret padding bytes method may mix the bytes at the check locations, but may not use varied mix values. Instead the bytes at each check location may always be mixed with the same value, for instance “0b1001 1001” or some other pattern chosen for maximum effect on the incremental check value. This may prevent reuse of the HMAC bits that were previously used to select which mix pattern to use. Such an implementation ensures the security of the HMAC bits and the secret padding lengths.

Referring to both FIGS. 2 and 3, the initial sample array locations and all subsequent sample array locations may calculated (Blocks 212, 312) from bits taken from the cryptographically-secure HMAC value, and may not be transmitted or used for any other purpose.

In one embodiment, the first sixteen bytes of the first calculated HMAC (Blocks 210, 310) may be used to select the initial sample array locations. The final four bytes of the first HMAC may be stored in the accumulation array which may be used to re-select sample array locations in the future. For example, and without limitation, at Blocks 212, 312, the sample array locations may be selected by first subdividing the packet into intervals. Any number of intervals may be used, although the 16 intervals used may correspond to the 16 bytes used from the HMAC. Two separate sample arrays may be employed for greater coverage of the data stream, but a single array or more than two may be used as well. With the 16-interval embodiment, between 1% and 2% of the data may be directly sampled within each average packet. Extraordinarily small packets may be sampled to a greater extent, but the average may be between 1% and 2% when using two sample arrays.

Another embodiment may employ 24 intervals, which may correspond to the 24 bytes accumulated from the HMACs. Two methods may be used to distribute the sample array locations, depending on the length of the packet. If the packet is less than or equal to 4,096 bytes (with the 16 sample location embodiment described above) then the first method may be used. Any longer packets may use the second method.

For the first method above, an offset value may be calculated by taking each byte of the sixteen accumulated HMAC bytes modulo the interval length as described above. Then, the offset may be added to the byte number which is the beginning of the corresponding interval. For example, with a 1,600 byte packet, each interval may be 100 bytes long (1,600 bytes/16 intervals), and the intervals may be numbered from 0 to the interval size minus 1. Interval 0 may be bytes 0-99, Interval 1 may be bytes 100-199, and so on. If the first byte of the HMAC bytes is 86, then the offset may be 86 modulo 100 (the interval length)=86. The offset may then be added to the corresponding interval's start location, which in the example case is 0 (Interval 0 starts at byte 0), for a sample array location of 86. The second sample location array may have its offset calculated the same way, but it may be subtracted from the next higher interval's start location and then decremented by one again. The complete expression for the each of the second sample array locations may be as follows:

((i+1)*intervalLength)−offset−1; with i being the current array location

The second method used to distribute the sample array locations, as described above, may be employed when the packet length is greater than 4,096 bytes. The offset may be calculated differently than the first method, but each interval may be offset the same way. For example, and without limitation, the offset may be calculated as follows:

((((intervalLength−1)/256)+1)*seedArray[i] modulo intervalLength); with seedArray[i] being the value of the HMAC byte being used to calculate the current sample array locations.

Packets less than 3,200 bytes in length (for example, in the 16 sample location embodiment described above) may use a sample size of 1. Packets 3,200 bytes or longer may use a larger sample size at each sample array location. This greater sample at each location may serve to keep the sample within the 1% to 2% target, and may be calculated by taking the interval length divided by 100. For example, and without limitation, a 3,200 byte packet may have an interval length of 200 (3,200 length/16 sample array locations), and so it may have a sample size of 2 (200 interval length/100). Packets with length less than 3,200 may be set to a sample size of 1 by definition, as a sample size of 0 is nonsensical. The packet sizes given are for example and without limitation, and may change based upon the number of sample locations used.

Sample size may be implemented by mixing the byte at each sample array location in the first array as usual, but then also mixing each subsequent byte for the duration of the sample size. For example, and without limitation, with a sample size of 3 (a packet with length 4,800 to 6,399, inclusive) and if the first sample location is byte 280, then bytes 280, 281, and 282 may all be mixed. The second location array may be calculated in reverse, as the sample array locations may actually be ending locations, rather than starting locations. Also for example, and without limitation, with the same sample size of 3, if the location in the second array is 184, then bytes 182, 183, and 184 may all be mixed. The second sample array may count in reverse in order to ensure more even coverage of all the possible bytes.

Also, referring to both FIGS. 2 and 3, the “modified” check value calculations at each of the bytes defined by the sample array locations are described in more detail below.

The Signature modules 114, 104 each may have a “mix” array that may be equal in length to the number of possible HMAC-bit combinations chosen for the security environment. For example, and without limitation, one embodiment may employ two HMAC bits per packet, so the mix array's length may be 4 (2²). If an embodiment required four HMAC bits per packet, the mix array's length may be 16 (2⁴), and so on. This mix array may have a predetermined byte for each element, with the bytes being chosen to make a specific unique bit pattern. A single byte per element may suffice as long as the security environment requires 8 or less HMAC bits per packet (length of 2⁸=256). For example, and without limitation, the first element may be “0b0111 1010”. The first element may be stored in array location 0 (arrays may be numbered starting at 0 in C-based languages), and may be used when the two HMAC bits are both 0, since 0b00=0. When a sample location byte is being processed, the byte from the data stream may first be XOR'ed with the mix array element matching the HMAC bits for the packet (Blocks 240, 340) before being fed into the incremental check value (Blocks 242, 342). For example, and without limitation, if the sample location byte is “0b1101 1011” and the HMAC bits are both 0 so the example mix byte is “0b0111 1010” (Blocks 240, 340), the check value may be calculated on “0b1010 0001”, which is the result of [0b1101 1011 XOR 0b0111 1010] (Blocks 242, 342), rather than being calculated on the data stream byte of “0b1101 1011”. However, to reiterate, the data stream may be transmitted unchanged (Blocks 250, 350), and “0b1101 1011” may still be forwarded to the I/O module rather than “0b1010 0001”.

As illustrated in FIGS. 3 and 4, the main loops of both Signature modules 114, 104 present the calculation of HMACs as being serial in nature. For example, and without limitation, depending on how powerful a processor the Sending server 111 and Receiver server 101 each may have and on how many cycles can be devoted to the Signature module 114, 104 on each, there may be a delay before the first incremental check signal may be sent while the Signature module 114, 104 calculates the initial HMAC. A person of skill in the art will immediately recognize, however, that concurrent processing is within the scope of the embodiments described herein.

For example, and without limitation, as soon as the Signature module 114 calculates each HMAC (initially at Block 210, and subsequently at Block 290), the Signature module 114 may begin calculating the subsequent HMAC as well at Block 290, and may store the HMAC in a working memory slot. For example, and without limitation, a two array method may be used: One array holding the current HMAC that may be subdivided and applied to the local data, and the other holding the next HMAC so that there is no delay once the current HMAC expires while the module calculates the subsequent HMAC. For example, and without limitation, the Signature module 114 may employ an array manager, which may swap the array pointers when the current HMAC expires and the Signature module 114 then may immediately begin calculating the subsequent HMAC. Each HMAC may contain enough independent bits to cover the number of packets between HMAC calculations.

For example, and without limitation, the raw HMAC value may be 160 bits, thereby allowing enough independent bits for 80 packets per HMAC at 2 bits per signature. If additional bits are required by the end user for more security, then the HMAC may be consumed more quickly (for example, and without limitation, 4 bits per signature may allow the HMAC to last for 40 packets), and may require more processing time to keep the HMAC calculations ahead of their consumption. In other embodiments, the Signature module 114 may use more than two arrays and may adjust the array pointers as necessary. Once all of the arrays are populated (Block 285), the HMAC calculation (Block 290) may stop. The HMAC calculation at Block 290 may be restarted every time an HMAC is fully consumed in order to refill the arrays.

In the embodiments described above, generally, the Receiver server 101 Signature module 104 may read in the header byte (Block 332) and may detect that the received counter value matches its internal counter value (Block 365). If the Signature module 104 detects a mismatch, the module 104 may generate an error alert (Block 370). In other embodiments, the Signature module 104 also may be configured with logic that allows for network jitter and/or malicious counter mismatches. For example, and without limitation, the module 104 may define an allowable “window” within a range of the current receiver counter value. If the Signature module 104 detects the received header packet's counter value is within this allowable window, and also detects that specific counter value has not already been successfully received, then the Receiver server 101 Signature module 104 may calculate the proper sample array locations and signature values using the received counter value. The Signature module 104 may then record that the specific counter value has been received so that it cannot be accepted in the future.

The allowable window may advantageously serve two purposes: 1) this mechanism may prevent obvious spoofing by using wildly different counter values in falsified packets, and also 2) may reduce the memory requirements of the data store 103 on the Receiver server 101. More specifically, rather than having to store every received counter value ever accepted, the Receiver server 101 may write to the data store 103 only the counter values accepted within the current rolling window. As the counter advances, the Signature module 104 may purge from the data store 103 previously received records once they are older than the window. The window also may prevent an adversary from copying a valid packet and then blocking the transmission of the valid packet with the intent of sending the packet at a future time and have it be accepted. Such a delay attack would only succeed if the blocked packet is retransmitted within the allowable window, which may be set by the Signature module 104 to be as small as practicable within the expected network conditions.

In one embodiment, the network condition should be nearly flawless over a direct Ethernet link between two devices, and the window may be reduced to only a single counter value in each direction of the range. A delay attack on this small window may only buy the adversary a two-packet delay before the blocked packet was invalidated. Less reliable networks, such as the Internet or a satellite uplink, may require larger windows, but not so large that adversaries are given a freely exploitable opportunity to launch a delay attack. In one embodiment, the Signature module 104 may use a 64 packet window, which a person of skill in the art may recognize as being sufficient for all but the most interference-riddled network conditions.

Employing this optional allowable window feature, the Receiver server's 101 Signature module 104 may attempt to calculate the signature using the received counter value, but may not change its own counter value unless the signature was verified, which is functionality characterized as housekeeping above. If a received header packet's counter value is within the window and results in a verified stream, the Receiver server 101 Signature module 104 may mark that counter value as received and may update its internal counter to match the received counter value if the received value is higher than the Receiver server's 101 counter. If the received value is lower than the Receiver server's 101 counter, the Signature module 104 may not roll back its counter, but instead may mark that counter value as received and continue, since the packet would have been a delayed packet and not the most current packet.

In the embodiments described above, generally, the main loop of the Signature module 114 (also representative of a second thread if employed in a multi-threaded environment) may be responsible for calculating a new HMAC (Block 290) every time the previous working HMAC has been fully consumed. Delays may be prevented by using the array swapping procedure at Block 212 where the current HMAC may be available in one array and the next HMAC is already calculated and waiting in a second array. As soon as the current HMAC is consumed, the array manager may seamlessly swap the array pointers to the waiting HMAC and may begin calculating the subsequent HMAC.

The array manager also may be responsible for dividing an HMAC into the proper components. For example, and without limitation, not all of each HMAC may be used to sign the data stream. In one embodiment, only 128 bits (16 bytes) may be used out of the 160-bit (20 byte) HMAC to directly sign a data stream. The remaining four bytes may be accumulated in a separate array. Once this array has 16 stored bytes, those accumulated bytes may be used to calculate new sample array locations. The sample array locations must change periodically in order to prevent the adversary from gathering enough data to make it possible to deduce the settings of the sample array locations.

In another embodiment, the array manager may use 112 bits (14 bytes) out of the 160-bit (20 byte) HMAC for signing, and may accumulate the remaining six bytes in a separate array. The array manager may then calculate new sample array locations (Block 212) once the separate array has 24 bytes stored. A person of skill in the art will recognize that the choice of embodiments is not limited to the above two, but instead may be established based on security requirements. For example, and without limitation, 19 bytes may be accumulated from every HMAC or, alternatively, just one byte.

In order to prevent longer-term replay attacks, these may be replay attacks greater than the distance monitored with the header byte, the full counter value may be embedded in the signature periodically. After each string of mixed bytes, and after the optional “secret-padding bytes” (if used), one byte (or other portion) of the full counter value may be added to the check value. By way of example, and not as a limitation, after the first string of mixed bytes, the Most Significant Byte of the counter value, which is represented as an 8 byte value in this example, may be added to the check value. After the second string of mixed bytes, the second most significant byte of the counter value may be added to the check value, and so on. There are at least 16 strings of mixed bytes in the 16 location embodiment. Therefore, the Least Significant Byte of the counter would be added after the eighth string of mixed bytes and the Most Significant Byte would be added again after the ninth string of mixed bytes. With the 16 location embodiment, the full counter value may be embedded at least twice, and it is acceptable for it to only be partially embedded on subsequent sets.

By way of example, and not as a limitation, if a 20 location embodiment is instead used rather than a 16 location embodiment, the full 8-byte counter value would be embedded 2.5 times. There is no need to add logic to ensure it is embedded an integer number of times as long as it is embedded at least one full time (which happens for any embodiment greater than or equal to 8 locations).

For versions with more mix locations, the full counter value can be added in a more piecewise fashion. After the first mix location, the 2 least significant bytes may be added to the check value. This may be accomplished by masking a copy of the counter to its least significant 16 bits. Then the local copy of the counter may be right-shifted by 1 bit, and the process may be repeated at all subsequent mix locations. With the SHA-512 version, discussed hereinafter, and 64 mix locations, this would result in the full eight byte counter value being embedded across all 64 locations, with each location having a version that is shifted by 1 bit.

A significant increase in security can be attained by switching to a larger-digest HMAC, such as SHA-512 instead of SHA-1. SHA-512 HMAC has an output of 512 HMAC bits as opposed to SHA-1 HMAC's 160 HMAC bits. SHA-512 HMAC has been shown to average only about twice the computational cost per HMAC. Using the increased number of cryptographically secure bits offered by SHA-512 HMAC, it is possible to increase the complexity of the first packet for each seed to 2¹⁶⁰, which is currently considered infeasible to brute force with modern computing resources. In order to achieve this complexity, both a larger Minimum Security Length and more sample locations are required. Rather than 16 locations and a new seed every four HMACs (using 4/20 bytes for reseeding each SHA-1-HMAC), it would use 64 locations and still new seed every four HMACs (using 16/64 bytes from each SHA-512-HMAC). Combining 64 locations with either a Minimum Security Length of 768 bytes (using 2 sample arrays) or a Minimum Security Length of 384 bytes (using only a single sample array) results in greater than the required 2¹⁶⁰ complexity for a Minimum Security Length packet (the actual complexity is 2¹⁶⁵). This increased security version would operate in the same manner as the SHA-1-HMAC (160-bit HMAC) version, which has 16 sample locations, except each HMAC in the increased security version is divided into a 48-byte section and a 16-byte section rather than a 16-byte section and a 4-byte section. The first section (48 bytes) is used to provide the HMAC bits used in the optional secret-padding bytes or the varied mix values. The second section (16 bytes) is accumulated in a separate array every HMAC until 64 bytes have been accumulated, at which point the sample location array(s) can be reseeded.

The additional bytes provided to the first section allow more HMAC bits to be used with each packet for greater security. By way of example, and not as a limitation, each packet could use 8 bits for the secret-padding bytes or the varied mix values, providing 2⁸ possible values per packet instead of the former 16 or 4, respectively. This still allows 48 packets to be checked for each SHA-512-HMAC. With reseeding every 4 HMACs, it provides 192 packets for each seed.

The increased complexity provided by SHA-512-HMAC offers an additional option. Using SHA-512 HMAC, it is possible to not reseed because the brute force space is so large. Eliminating reseeding lowers the computational requirements even further, albeit at a slight theoretical cost to security. When taking into account reseeding every 4 HMACs, the reseeding embodiment averages 48 packets per major calculation (recalculating the HMAC), but if reseeding is omitted, then the full 64 bytes can be used, increasing the average to 64 packets per major calculation. This can be further increased by reducing the number of HMAC bits used per packet back down to 4 or 2 as described with other embodiments. Such an embodiment would allow 128 or 256 packets per major calculation, respectively. This is compared to traditional signatures which require two major calculations (a hash and an encryption of that hash) for every packet.

A hash-based data stream authentication system and associated methods, according to an embodiment of the present invention, may support a variety of key sharing methods. For example, and without limitation, the following are examples of key sharing:

(1) Employ separate communications ports on both a sending device and a receiving device, and use a short-length and shielded cable to connect both ports. Pressing a button on the sending device may cause overwriting of a first key stored in the receiver with a second key stored on the sender. This method may also reset the clocks on both devices to guard against an adversary surreptitiously connecting his own receiver and pressing the button on the sender in an attempt to steal the key. Resetting the clock on the sender may cause that clock to no longer synchronize with the authentic receiver, and may thus advantageously trigger an immediate alarm of the adversary's action.

(2) Use the same port or connection type that the host devices use (for example, and without limitation, Ethernet, coaxial cable, or WiFi), with a preference to wired connections, and directly connect the two devices with a short range cable. Such a configuration may allow use of existing ports on the sending and receiving hosts without any hardware modification (i.e., a fully software addition to advantageously save costs of deployment). A person of skill in the art may recognize that some type of transmission trigger, such as a simple button, may be added if the Sender server 111 otherwise has no human input/output capabilities. For example, and without limitation, although a short, temporary communication connection may be desirable to minimize exposure to eavesdropping, the present implementation may be employed in conjunction with a longer, permanent connection.

(3) Configure a software-only implementation, with no modification to the host hardware (e.g., no addition of a button as a transmission trigger). For example, and without limitation, the above same-port version (2) may be used where the sender may be configured to test latency of the connection on startup, and to automatically send the key if the latency is characterized by some low value that could only be achieved with a cable less than 2 meters in length.

(4) Add hardware security modules to both devices. For example, and without limitation, hardware security modules may be of a commercially-available type that may store sensitive data on a tamper-resistant chip that may be configured to erase itself after a certain number of failed access attempts. Also for example, and without limitation, the hardware security modules may either be removable or may exhibit the short-length communications port described in version (1) above integrated into their exterior. The removable versions may be attached to each other using the same pins used to connect them with the host devices, and one of the hardware security modules (for example, and without limitation, the sender's modules) may then overwrite the other module using their direct connection to prevent eavesdropping. Subsequent to an overwrite, the two modules may be reinstalled in the host devices. The short-length communications port may function just as version (1) above, except that the keys may be stored on the hardware security module instead of non-volatile memory. A person skilled in the art may recognize that the host modifications described above may represent high-security implementations, but may come at significant cost.

(5) The host devices may be pre-provisioned during fabrication with pairs of unique keys shared on matched devices, thus eliminating the need for an end user to share the keys in an insecure fashion. This method of sharing may also be enhanced with any of the key generation methods described below, advantageously allowing an easy initial setup (due to the pre-shared and pre-provisioned key) and also allowing the user to update the key in a way that provides additional security. User-directed updating of keys also may allow a user to replace a single device upon failure, rather than requiring acquisition of a replacement, pre-provisioned pair of host devices.

(6) The sender's key may be archived (for example, and without limitation, printed) to a secure location on the sender, where this key may subsequently be read by a human user and manually typed into a configuration screen of the receiver. Protected locations may include any place that requires the sender to be disconnected from data communication media in order to read the key, as disconnecting the sender would signal an alarm to the receiver, allowing security to investigate if an adversary were reading the key. For example, the key could be printed on the inside of the sender's enclosure and opening the enclosure signals a tamper alarm. It could also be printed such that an essential component is only viewable when the power supply is unplugged (e.g., by printing it inside the sender's power port such that it is not viewable when the power supply is connected), or when the transmission port is disconnected (e.g., by printing inside the Ethernet port or other communication port).

(7) Allow a user to generate his own secret key and to type the key into a configuration interface(s) for both the sender and receiver. For example, and without limitation, both the sender and receiver may be configured to present means for human input/output (I/O), such as if both are personal computers or similar devices characterized by directly-attached physical or virtual keyboards. Such functionality also may be made available on hosts that were not originally configured to include human-interaction capabilities by adding either a port (for example, and without limitation, a PS/2 or USB port) to both host devices, and by having that port allow connection of standard, mass-market keyboards. The interface port instead may be added to just one device, and then one of the above overwrite methods may be used to share the newly-typed key with the other device.

(8) All of the key sharing versions above that specifically mention sender-overwrites-receiver, or vice versa, may be reversed such that receiver-overwrites-sender, or vice versa.

A hash-based data stream authentication system and associated methods, according to an embodiment of the present invention, may support of a variety of key generation methods. For example, and without limitation, the following are examples of key generation:

(1) One of the devices (preferably the sender if using one of the sender-overwrites-receiver key sharing methods above) may be configured with an ability to generate a new key on command by seeding a random number generator with the existing key and current time, and then pseudo-randomly (or cryptographically-randomly, if appropriate code is added) selecting a new value for each key element. For example, and without limitation, this approach may be used either as preemptive security followed by sharing as above, or in response to a suspected security breach. This approach does not expose the new key to any human users, thereby advantageously preventing coercion and/or the scenario of an adversary gaining access to mishandled documentation upon which the key may be exposed.

(2) If either of the host devices is configured with human I/O capability, then the user may manually generate his own secret key and enter that key on whichever host device is characterized by the human I/O. Subsequently, one of the sharing methods above may be used to transfer the new key to the other host device.

(3) If neither of the host devices is configured with human I/O capability, but hardware modification is possible and allowable, method (7) of the key sharing above may be used by adding a port (for example, and without limitation, a USB or PS/2 port) to one or both of the devices, and then allowing the user to generate his own secret key and to enter it directly to one or both devices. If entered into only one device, then any of the sharing methods above that feature overwrite may be used to share the key through transmission to the non-interactive device(s).

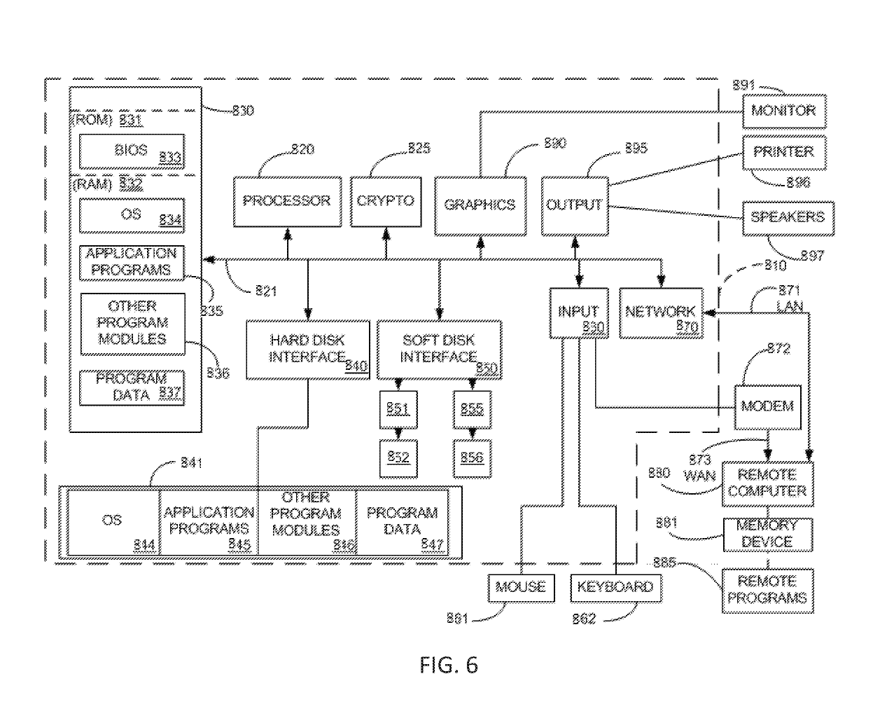

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 6 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 6 illustrates an operating system (OS) 834, application programs 835, other program modules 836, and program data 837.

The computer 810 may also include other removable/non-removable, volatile/nonvolatile computer storage media. By way of example only, FIG. 6 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 6, provide storage of computer readable instructions, data structures, program modules and other data for the computer 810. In FIG. 6, for example, hard disk drive 841 is illustrated as storing an OS 844, application programs 845, other program modules 846, and program data 847. Note that these components can either be the same as or different from OS 834, application programs 835, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 6. The logical connections depicted in FIG. 6 include a local area network (LAN) 871 and a wide area network (WAN) 873, but may also include other networks 150. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 6 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. The scope of the invention should be determined by the appended claims and their legal equivalents, and not by the examples given. Therefore, it is understood that the invention is not to be limited to the specific embodiments disclosed.

The invention claimed is:

1. A method of creating a secure check value for a set of data, comprising:
a) calculating a cryptographic digest of a counter value using a key;
b) combining the set of data and at least one bit from the cryptographic digest into an intermediate product; and
c) applying a checksum or hash algorithm to the intermediate product.

2. The method of claim 1 wherein the cryptographic digest is calculated using an HMAC function (defined in FIPS PUB 198-1).

3. The method of claim 2 wherein the HMAC function uses a SHA-512 cryptographic hash function (defined in FIPS PUB 180-4).

4. The method of claim 1 wherein the step of combining the set of data and the at least one bit from the cryptographic digest is accomplished by adding a value to the intermediate product at one or more locations.

5. The method of claim 4 wherein the value added to the intermediate product is selected using an algorithm or table which takes the at least one bit from the cryptographic digest as its input or one of its inputs.

6. The method of claim 4 wherein the one or more locations are calculated using at least one bit from the cryptographic digest.

7. The method of claim 1 further comprising incorporating at least one bit of the counter value into the intermediate product at one or more locations of the intermediate product.

8. The method of claim 7 wherein two or more locations of the intermediate product are used and a different subset of one or more bits from the counter value is incorporated into the intermediate product at each subsequent location until all of the bits of the counter value have been incorporated at least once.

9. The method of claim 1 further comprising:
a) checking if the set of data is at least a minimum length after creating the intermediate product; and
b) modifying the intermediate product by adding one or more padding bytes before the step of applying a checksum or hash algorithm to the intermediate product.

10. The method of claim 9 wherein the minimum length is 384 bytes.

11. The method of claim 9 further comprising modifying the intermediate product by combining at least one of the padding bytes with at least one bit from the cryptographic digest.

12. A method of using a first secure check value with a set of data which comprises the steps of:
a) creating the first secure check value using a first counter value, a key, and the set of data; and
b) associating the first secure check value with the set of data.

13. The method of claim 12 further comprising associating an identifier with the first check value and the set of data.

14. The method of claim 13 wherein the identifier further comprises the size of the associated set of data.

15. The method of claim 12 further comprising:
a) calculating a second secure check value using a second counter value, the key, and the set of data; and
b) comparing the second secure check value with the first secure check value.

16. The method of claim 15 further comprising transferring the first check value and the set of data to a different location before calculating the second secure check value.

17. The method of claim 15 wherein the second secure check value is calculated at a future point in time.

18. The method of claim 15 wherein the second check value is calculated with the second counter value being different than the first counter value.

19. The method of claim 15 further comprising informing a user that the second secure check value is identical to the first secure check value or that the second secure check value is not identical to the first secure check value.

20. The method of claim 19 wherein the user is a software program.

21. The method of claim 12 further comprising:
a) recognizing a new set of data is available to be secured; and
b) starting the method again from step (a) of claim 12 for each new set of data to be secured.

22. An authentication system comprising:
a) a first network interface which receives information comprising a data set and transmits information comprising the data set and a secure check value;
b) a first data store with at least the capacity to store data comprising a secret key, a counter value, the secure check value, and an array of byte locations;
c) a first processor connected to the first network interface and the first data store which implements the instructions required to calculate the secure check value;
d) a second network interface which receives information comprising the data set and the secure check value and transmits information comprising the data set and whether or not the data set was authenticated;
e) a second data store with at least the capacity to store data comprising the secret key, the counter value, the secure check value, and the array of byte locations; and
f) a second processor connected to the second network interface and the second data store which implements the instructions required to calculate the secure check value.

23. The authentication system of claim 22 further comprising at least one hardware security module which interfaces with at least one processor.

24. The authentication system of claim 22 wherein the first processor and the first data store, the first network interface, or a combination thereof, or the second processor and the second data store, the second network interface, or a combination thereof are integrated into a single component.

25. The authentication system of claim 22 wherein the first processor, the first data store, the first network interface or combinations thereof are implemented as software rather than discrete components.

26. The authentication system of claim 22 wherein the second processor, the second data store, the second network interface or combinations thereof are implemented as software rather than discrete components.

27. The authentication system of claim 22 further comprising additional processors, data stores, and network interfaces, or combinations thereof.
